(19) United States
(12) Patent Application Publication
(10) Pub. No.: US 2026/0146793 A1
(43) Pub. Date: May 28, 2026

(54) HOT AIR GENERATION APPARATUS

(71) Applicant: Taikisha Ltd., Tokyo (JP)

(72) Inventors: Kozo ISHIDA, Nishinomiya-shi (JP); Toshihiko KOIKE, Isesaki-shi (JP); Hiroaki TAKAHASHI, Saitama-shi (JP)

(73) Assignee: Taikisha Ltd., Tokyo (JP)

(21) Appl. No.: 19/454,299

(22) Filed: Jan. 20, 2026

Related U.S. Application Data
(63) Continuation of application No. PCT/JP2024/023914, filed on Jul. 2, 2024.

(30) Foreign Application Priority Data
Jul. 21, 2023 (JP) 2023-119272

(51) Int. Cl. F26B 15/12; F24H 3/04

(52) U.S. Cl. CPC F26B 15/12; F24H 3/0405

(57) ABSTRACT

A hot air generation apparatus for performing heating processing concerning a dry gas in a coating drying oven, includes a heating chamber to which the dry gas is supplied, and an electric flow heater attached to a wall portion of the heating chamber The electric flow heater includes a heating unit provided with a heating element, an introduction portion provided outside the heating chamber to introduce a gas to pass through the heating unit, a discharge portion provided inside the heating chamber to discharge the gas that has passed through the heating unit, and an electric connection terminal provided outside the heating chamber and configured to supply power to the heating element.

### CROSS-REFERENCE TO RELATED APPLICATION(S)

This application is a Continuation of International Patent Application No. PCT/JP2024/023914, filed Jul. 2, 2024, which claims the benefit of Japanese Patent Application No. 2023-119272, filed Jul. 21, 2023, both of which are hereby incorporated by reference herein in their entirety.

### BACKGROUND OF THE INVENTION

### Field of the Invention

The present invention relates to a hot air generation apparatus.

### Description of the Related Art

A coating drying oven for drying a coating on an automobile or the like is provided with a hot air generation apparatus such as a hot air circulation apparatus configured to heat a dry gas to be circulated to the coating drying oven or a heat treatment apparatus configured to remove tar when discharging the dry gas into the atmosphere (for example, Japanese Patent No. 3251157). As the heat source of such a hot air generation apparatus, a gas burner is widely used.

To prevent global warming, industries are being required to reduce carbon dioxide emissions. It is preferable to use heat sources with lower carbon dioxide emissions, replacing gas burners.

### SUMMARY OF THE INVENTION

It is an object of the present invention to provide a hot air generation apparatus capable of reducing carbon dioxide emissions.

According to an aspect of the present invention, there is provided a hot air generation apparatus for performing heating processing concerning a dry gas in a coating drying oven, comprising: a heating chamber to which the dry gas is supplied; and an electric flow heater attached to a wall portion of the heating chamber, wherein the electric flow heater comprises: a heating unit provided with a heating element; an introduction portion provided outside the heating chamber to introduce a gas to pass through the heating unit; a discharge portion provided inside the heating chamber to discharge the gas that has passed through the heating unit; and an electric connection terminal provided outside the heating chamber and configured to supply power to the heating element.

Further features of the present invention will become apparent from the following description of exemplary embodiments (with reference to the attached drawings).

### BRIEF DESCRIPTION OF THE DRAWINGS

FIG. 1 is a schematic view of a coating drying system;

FIG. 2 is a view showing a configuration near an electric flow heater;

FIG. 3A is a sectional view of the electric flow heater;

FIG. 3B is a sectional view taken along a line A-A in FIG. 3A and a partially enlarged view;

FIG. 4A is a view showing a configuration near another electric flow heater;

FIG. 4B is a sectional view of the other electric flow heater;

FIG. 5A is a flowchart showing an example of processing of a control apparatus;

FIG. 5B is a flowchart showing an example of processing of the control apparatus;

FIG. 6A is a flowchart showing an example of processing of the control apparatus;

FIG. 6B is a flowchart showing an example of processing of the control apparatus;

FIG. 7 is a schematic view of another coating drying system;

FIG. 8 is a view showing another example of a support member;

FIG. 9 is a view showing another example of a heat treatment apparatus;

FIG. 10 is a schematic view of a coating drying system using a gas burner;

FIG. 11 is an explanatory view showing an example of exchange of a gas burner and an electric flow heater; and

FIG. 12 is an explanatory view showing an example of exchange of a gas burner and an electric flow heater.

### DESCRIPTION OF THE EMBODIMENTS

Hereinafter, embodiments will be described in detail with reference to the attached drawings. Note that the following embodiments are not intended to limit the scope of the claimed invention, and limitation is not made to an invention that requires all combinations of features described in the embodiments. Two or more of the multiple features described in the embodiments may be combined as appropriate. Furthermore, the same reference numerals are given to the same or similar configurations, and redundant description thereof is omitted.

### First Embodiment

### Coating Drying System

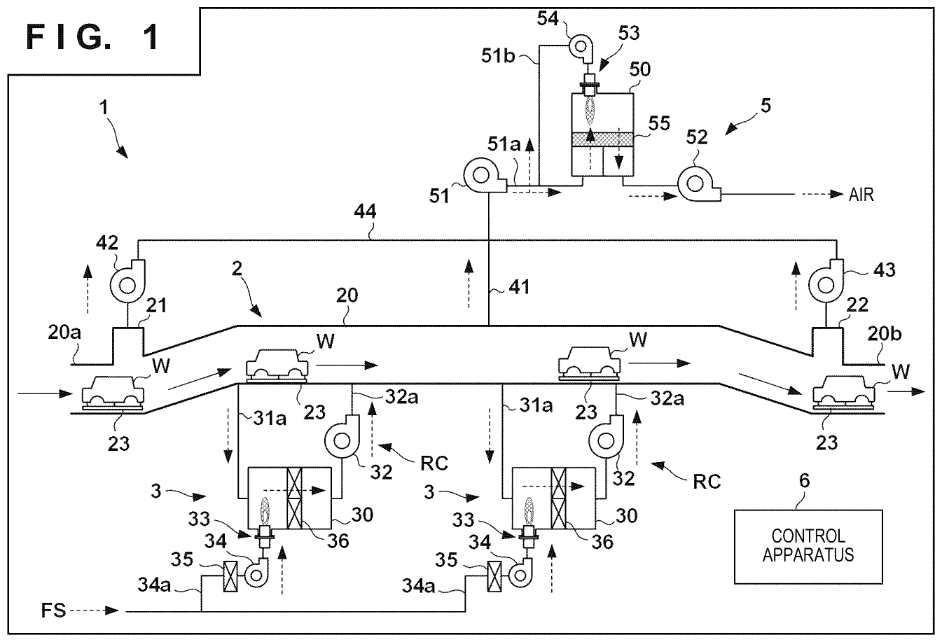

FIG. 1 is a schematic view of a coating drying system 1. The coating drying system 1 is a system that performs a baking-finish drying process of a coating film of a workpiece W. Here, the workpiece W is assumed to be an automobile body. The coating drying system 1 includes a coating drying oven 2, a plurality of hot air circulation apparatuses 3, a heat treatment apparatus 5, and a control apparatus 6. The coating drying oven 2 includes a cylindrical wall body 20 that has an inlet 20a and an outlet 20b for the workpiece W and forms a drying space therebetween. The workpiece W is conveyed by a conveyance apparatus 23 such that it passes from the inlet 20a to the outlet 20b, and the coating film of the workpiece W is dried during this time. Both the hot air circulation apparatus 3 and the heat treatment apparatus 5 are examples of a hot air generation apparatus that generates hot air.

The hot air circulation apparatus 3 is a supply apparatus that supplies a dry gas of high temperature to the coating drying oven 2. In this embodiment, two hot air circulation apparatuses 3 are provided. In this embodiment, the dry gas is heated air. Three or more hot air circulation apparatuses 3 may be provided. The hot air circulation apparatus 3 includes a heating chamber 30, and a circulation unit RC that circulates the dry gas between the heating chamber 30 and the coating drying oven 2.

The circulation unit RC supplies the dry gas in the coating drying oven 2 to the heating chamber 30 via an air path 31a communicating with the coating drying oven 2. An electric flow heater 33 is provided as a heat source in the heating chamber 30. The electric flow heater 33 heats fresh outside air FS sent by a fan 34, and the heated fresh outside air FS is blown into the heating chamber 30. The fan 34 takes in the fresh outside air FS via an air path 34a and sends it to the electric flow heater 33. A filter 35 is provided halfway along the air path 34a, and the filter 35 removes foreign substances such as dust in the fresh outside air FS.

The inside of the heating chamber 30 is partitioned by a filter 36 into a space on an upstream side and a space on a downstream side. To the space on the upstream side, the dry gas is sent from the coating drying oven 2, and the heated fresh outside air FS is introduced from the electric flow heater 33. The dry gas and the fresh outside air FS are mixed, thereby generating a dry gas of high temperature.

The circulation unit RC includes a fan 32, and the dry gas from which foreign substances are removed by the filter 36 is returned by the fan 32 to the coating drying oven 2 via an air path 32a communicating with the coating drying oven 2. The returned dry gas is blown from a plurality of nozzles provided in the coating drying oven 2 into the coating drying oven 2, thereby drying the coating film of the workpiece W. In this way, the dry gas is heated by the hot air circulation apparatus 3 while being circulated between the coating drying oven 2 and the hot air circulation apparatus 3, and the dry gas in the coating drying oven 2 can thus be maintained at a predetermined temperature.

The heat treatment apparatus 5 is a regenerative thermal oxidizer that burns and detoxifies harmful substances in the dry gas and discharges the gas. Examples of the harmful substances are VOCs (Volatile Organic Compounds) and tar. The heat treatment apparatus 5 detoxifies harmful substances by heating and oxidizing these.

The heat treatment apparatus 5 includes a heating chamber 50. The dry gas is supplied by a fan 51 to the heating chamber 50 via an air path 51a. The dry gas is introduced to the fan 51 via an air path 41, fans 42 and 43, and an air path 44. The fan 42 takes in the dry gas from a hood portion 21 provided at the inlet 20a and sends it to the fan 51 via the air path 44. The fan 43 takes in the dry gas from a hood portion 22 provided at the outlet 20b and sends it to the fan 51 via the air path 44.

An electric flow heater 53 is provided as a heat source in the heating chamber 50. The electric flow heater 53 heats the gas sent by a fan 54, and the heated gas is blown into the heating chamber 50. The gas sent by the fan 54 may be the fresh outside air, but the dry gas is used in this embodiment. More specifically, the dry gas is supplied from the fan 51 to the fan 54 via an air path 51b branched from the air path 51a, and sent from the fan 54 to the electric flow heater 53. When the dry gas is used as the gas to be supplied to the electric flow heater 53, burning and detoxification of harmful substances in the dry gas can be promoted. In addition, if the already heated dry gas is used, the temperature in the heating chamber 50 can be raised using less energy.

The inside of the heating chamber 50 is partitioned by a catalyst 55 into a lower space and an upper space. A part of the dry gas is sent from the fan 51 to the lower space. The heated dry gas is introduced from the electric flow heater 53 to the upper space. A part of the dry gas sent from the fan 51 is heated by the dry gas heated by the electric flow heater 53 and passed through the catalyst 55 and thus detoxified. The detoxified dry gas is discharged by a fan 52 to the atmosphere.

The control apparatus 6 is an electronic circuit that controls the entire coating drying system 1. The control apparatus 6 includes, for example, a processor such as a CPU, a storage device such as a semiconductor memory, an input/output interface that inputs/outputs a signal from/to an external device, a communication interface that performs communication with a host device, an input device that accepts an operation of an operator, and a display device that displays information to the operator. The processor executes programs stored in the storage device, thereby controlling actuators that form the coating drying system 1. The host device is, for example, a computer that controls an overall coating facility including the coating drying system 1.

### Electric Flow Heater

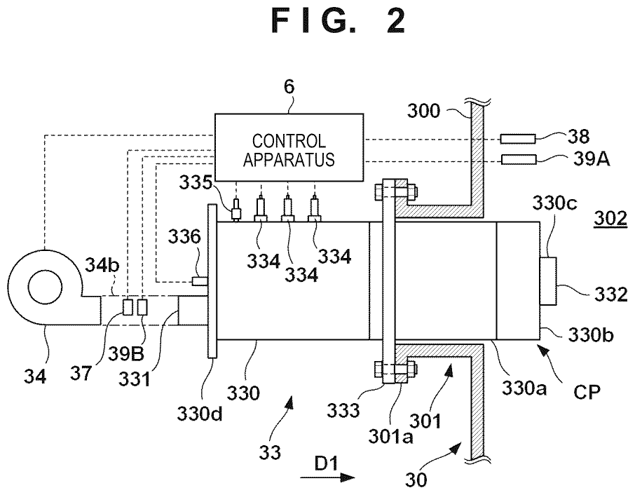

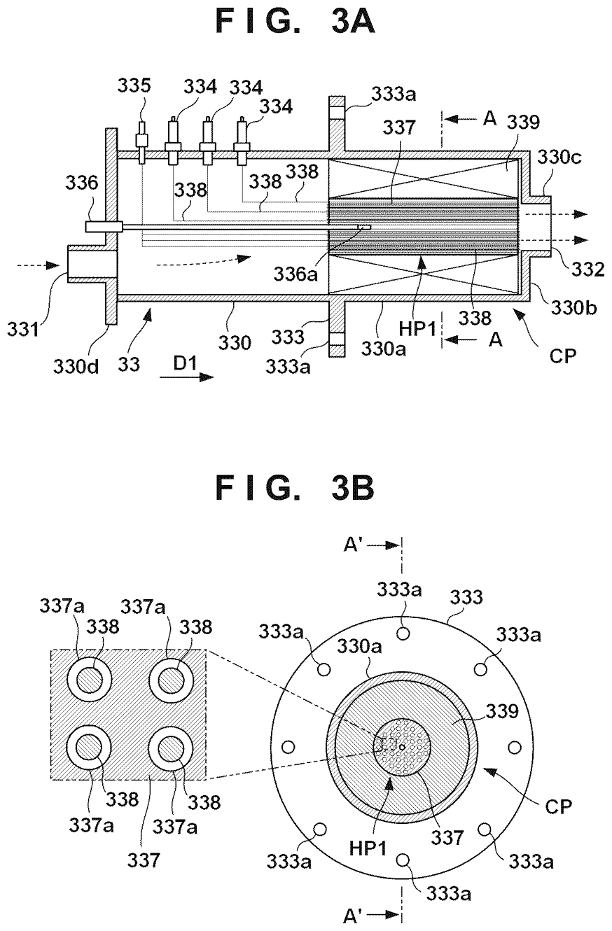

The electric flow heater 33 will be described with reference to FIGS. 2 to 3B. FIG. 2 is a view showing a configuration near the electric flow heater 33. FIG. 3A is a sectional view of the electric flow heater 33 and corresponds to a sectional view taken along a line A′-A′ in FIG. 3B. FIG. 3B shows a sectional view taken along a line A-A in FIG. 3A and a partially enlarged view.

The electric flow heater 33 has an axial or columnar outer appearance extended in a direction D1 as a whole, and includes an introduction portion 331 for a gas (fresh outside air FS) at one end portion in the direction D1 and a discharge portion 332 that discharges the heated gas at the other end portion. The introduction portion 331 is located outside the heating chamber 30, and the fan 34 is connected to the introduction portion 331 via an air path 34b. Since the introduction portion 331 is located outside the heating chamber 30, it is possible to easily conduct the work of installing/piping the fan 34 and the air path 34b.

The electric flow heater 33 includes a case member 330 that is made of a metal and forms the outer wall of the electric flow heater. The case member 330 has a hollow cylindrical shape as a whole, and a disc-shaped flange portion 333 radially projecting from the case member 330 is integrally formed at a midway portion of the case member in the direction D1. The electric flow heater 33 is fixed by the flange portion 333 to a wall portion 300 forming the outer wall of the heating chamber 30. More specifically, an attachment portion 301 having a cylindrical shape is formed on the wall portion 300, and a flange portion 301a having the same shape as the flange portion 333 is provided on the attachment portion 301. A plurality of attachment holes 333a are formed in the flange portion 333 in the circumferential direction, and the flange portion 333 and the flange portion 301a are fixed by bolt/nut fastening. In a state in which the electric flow heater 33 is fixed to the wall portion 300, the discharge portion 332 is located in the internal space 302 of the heating chamber 30.

One end portion of the case member 330 is closed by an end plate 330d. The above-described introduction portion 331 is formed on the end plate 330d. The introduction portion 331 has a cylindrical shape communicating with the inside of the case member 330.

A heating unit HP1 is incorporated in the case member 330. The heating unit HP1 is located in the internal space 302 of the heating chamber 30. The heating unit HP1 includes a plurality of heating elements 338, and a support member 337 that supports the heating elements 338. The heating element 338 is a wire that generates heat upon receiving supplied power and is, for example, a nichrome wire or a Kanthal wire. In the example shown in FIG. 3A, three heating elements 338 are used. The support member 337 is a member having a columnar shape in which a number of holes 337a extending in the direction D1 are formed. The support member 337 is, for example, a ceramic material.

The hole 337a forms an air passage and functions as a support hole for the heating element 338. Each heating element 338 passes through one hole 337a, and is then folded back to pass through another hole 337a and folded back again to pass through still another hole 337a. In this way, each heating element 338 reciprocally passes through the support member 337 in the direction D1, thereby passing through a plurality of holes 337a. When the heating elements 338 generate heat, the gas passing through the holes 337a can be heated. If the support member 337 is a ceramic material, the gas can be heated to a higher temperature by emission of far infrared rays and can be heated to, for example, 1,000° C. or more.

Electric connection terminals 334 corresponding to the heating elements 338 and an electric connection terminal 335 set to the GND potential are provided on the peripheral wall of the case member 330. The electric connection terminals 334 and 335 are arranged between the end plate 330d and the flange portion 333. One terminal of the heating element 338 is connected to the corresponding electric connection terminal 334, and the other terminal is connected to the electric connection terminal 335. The wirings of a driving circuit are connected to the electric connection terminals 334 and 335, and energization is controlled by the control apparatus 6. The electric connection terminals 334 and 335 are located outside the heating chamber 30 and exposed to the outside of the case member. This improves the workability of wiring work or maintenance work of the electrical system.

A heat insulator 339 is provided so as to surround the heating unit HP1. The heat insulator 339 is formed by, for example, winding a band-shaped heat insulating material on the heating unit HP1, or has a cylindrical shape covering the heating unit HP1. The heat insulator 339 is, for example, ceramic fiber. When the heat insulator 339 is provided around the heating unit HP1, it is possible to insulate the heating unit HP1 from heat in the internal space 302 of the heating chamber 30 and reduce the influence of the temperature in the internal space 302 on the heating unit HP1.

If the heat insulator 339 deteriorates due to use, it may be a dust generation source. Since the dry gas heated by the hot air circulation apparatus 3 is returned to the coating drying oven 2, it is not favorable that the dry gas contains dust. In this embodiment, the case member 330 includes a cover portion CP that covers the heat insulator 339.

The cover portion CP is formed from the flange portion 333 to the side of the heating chamber 30 and integrated with the flange portion 333. The cover portion CP includes an outer cylinder portion 330a, an end plate portion 330b, and a nozzle portion 330c. The outer cylinder portion 330a has a cylindrical shape and covers the peripheral surface of the heat insulator 339. The end plate portion 330b closes the end portion of the outer cylinder portion 330a (the end portion of the case member 330) and covers the end portion of the heat insulator 339. The nozzle portion 330c is a cylindrical member that is formed on the end plate portion 330b to form the discharge portion 332, and faces the end portion of the heating unit HP1. The opening area of the nozzle portion 330c is slightly smaller than the end portion of the heating unit HP1. Since the heat insulator 339 is covered with the cover portion CP, even if dust is generated, outflow of it to the outside can be suppressed.

With the above-described configuration, as indicated by a broken arrow in FIG. 3A, the fresh outside air FS introduced from the introduction portion 331 into the case member 330 by the fan 34 is heated when passing through the heating unit HP1, and blown from the discharge portion 332 into the internal space 302 of the heating chamber 30. The temperature of the heated fresh outside air FS can be controlled by the air flow of the fan 34 and power to the heating elements 338.

Examples of sensors used to control the hot air circulation apparatus 3 will be described. A temperature sensor 38 and a pressure sensor 39A are provided in the heating chamber 30. An air flow sensor 37 and a pressure sensor 39B are provided in the air path 34b. A temperature sensor 336 is provided in the electric flow heater 33.

The temperature of the gas passing through the electric flow heater 33 can be detected by the temperature sensor 38, and temperature adjustment in the heating chamber 30 (temperature adjustment of the dry gas) can be performed by controlling the air flow of the fan 34 or the power supplied to the heating elements 338 based on the detection result. A pressure loss of the gas passing through the electric flow heater 33 can be detected based on the detection results of the pressure sensors 39A and 39B. If the pressure loss is large, it can be determined that the resistance to the gas passing through the heating unit HP1 is high, that is, clogging or the like has occurred due to deterioration with use, and this can be used as a guide for exchange or maintenance of the support member 337.

The air flow of the fan 34 can be detected by the air flow sensor 37, and the fan 34 can be controlled based on the detection result. Also, the detection result of the air flow sensor 37 can be used as a guide for exchange or maintenance of the support member 337. That is, if the detection result of the air flow sensor 37 indicates a remarkably low air flow with respect to the output of the fan 34, it can be determined that the resistance to the gas passing through the heating unit HP1 is high, that is, clogging or the like has occurred due to deterioration with use. The temperature sensor 336 is a sensor that detects the temperature of the heating unit HP1, and a temperature detection unit 336a is arranged in the support member 337. Temperature control of the heating unit HP1 or disconnection estimation of the heating element 338 (the temperature is low with respect to the energization amount) can be done based on the detection result of the temperature sensor 336.

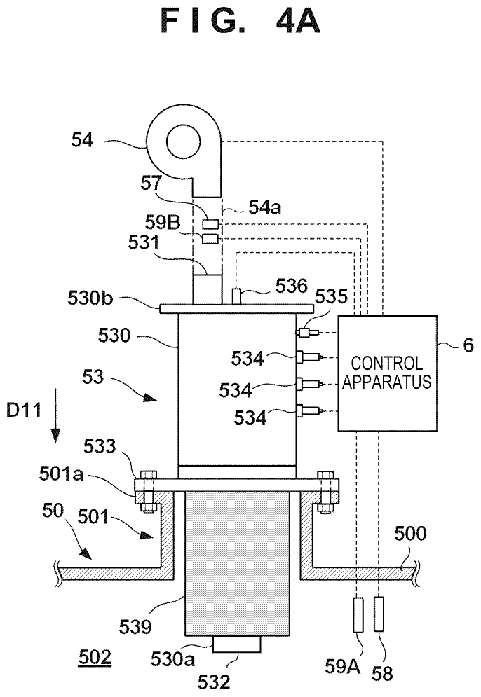

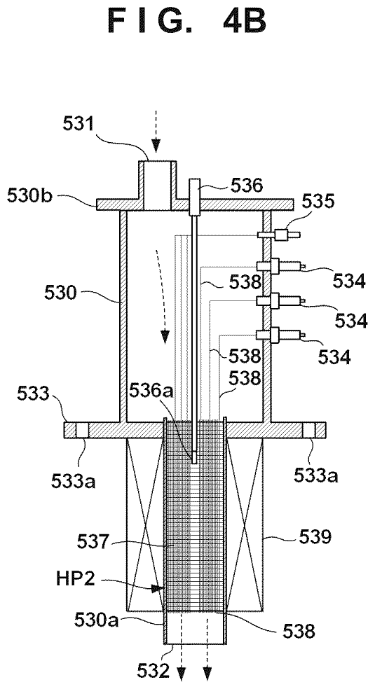

The electric flow heater 53 will be described next with reference to FIGS. 4A and 4B. The basic configuration of the electric flow heater 53 is the same as the electric flow heater 33, and different points will mainly be described below. FIG. 4A is a view showing a configuration near the electric flow heater 53. FIG. 4B is a sectional view of the electric flow heater 53 and corresponds to the sectional view of FIG. 3A used for the explanation of the electric flow heater 33.

The electric flow heater 53 has an axial or columnar outer appearance extended in a direction D11 as a whole, and includes an introduction portion 531 of the dry gas at one end portion in the direction D11 and a discharge portion 532 that discharges the heated gas at the other end portion. The introduction portion 531 is located outside the heating chamber 50, and the fan 54 is connected to the introduction portion 531 via an air path 54a.

The electric flow heater 53 includes a case member 530 that is made of a metal and forms the outer wall of the electric flow heater. The case member 530 has a hollow cylindrical shape as a whole, and a disc-shaped flange portion 533 radially projecting from the case member 530 is integrally formed at a midway portion of the case member in the direction D11. The electric flow heater 53 is fixed by the flange portion 533 to a wall portion 500 forming the outer wall of the heating chamber 50. More specifically, an attachment portion 501 having a cylindrical shape is formed on the wall portion 500, and a flange portion 501a having the same shape of the flange portion 533 is provided on the attachment portion 501. A plurality of attachment holes 533a are formed in the flange portion 533 in the circumferential direction, and the flange portion 533 and the flange portion 501a are fixed by bolt/nut fastening. In a state in which the electric flow heater 53 is fixed to the wall portion 500, the discharge portion 532 is located in the internal space 502 of the heating chamber 50.

One end portion of the case member 530 is closed by an end plate 530b. The above-described introduction portion 531 is formed on the end plate 530b. The introduction portion 531 has a cylindrical shape communicating with the inside of the case member 530.

A heating unit HP2 is incorporated in the case member 530. The heating unit HP2 has the same structure as the heating unit HP1 and includes a plurality of heating elements 538, and a support member 537 that supports the heating elements 538. The heating element 538 and the support member 537 are the same as the heating elements 338 and the support member 337 of the electric flow heater 33. Electric connection terminals 534 corresponding to the heating elements 538 and an electric connection terminal 535 set to the GND potential are provided on the peripheral wall of the case member 530.

The case member 530 includes a cylinder portion 530a that supports the heating unit HP2. The cylinder portion 530a is a member having a cylindrical shape and extended from the flange portion 533 to the side of the heating chamber 50 in the direction D11, and its end portion forms the discharge portion 532.

A heat insulator 539 is provided so as to surround the heating unit HP2. The heat insulator 539 is a member similar to the heat insulator 339 of the electric flow heater 33 and is formed by, for example, winding a band-shaped heat insulating material on the cylinder portion 530, or has a cylindrical shape surrounding the cylinder portion 530.

If the heat insulator 539 deteriorates due to use, it may be a dust generation source, but the dry gas heated by the heat treatment apparatus 5 is discharged without being returned to the coating drying oven 2. For this reason, unlike the electric flow heater 33, the electric flow heater 53 does not include a member that covers the heat insulator 539. However, as the electric flow heater 53, an electric flow heater having the same structure as the electric flow heater 33 with the cover portion CP may be used, as a matter of course.

With the above-described configuration, as indicated by a broken arrow in FIG. 4B, the dry gas introduced from the introduction portion 531 into the case member 530 by the fan 54 is heated when passing through the heating unit HP2, and blown from the discharge portion 532 into the internal space 502 of the heating chamber 50. The temperature of the heated dry gas can be controlled by the air flow of the fan 54 and power to the heating elements 538.

Examples of sensors used to control the heat treatment apparatus 5 will be described. In this embodiment, sensors similar to those in the hot air circulation apparatus 3 are provided in the heat treatment apparatus 5. A temperature sensor 58 and a pressure sensor 59A are provided in the heating chamber 50, an air flow sensor 57 and a pressure sensor 59B are provided in the air path 54a, and a temperature sensor 536 with a temperature detection unit 536a provided on the support member 537 is provided in the electric flow heater 53.

How to use the detection results of the temperature sensor 58, the pressure sensors 59A and 59B, the air flow sensor 57, and the temperature sensor 536 is the same as the temperature sensor 38, the pressure sensors 39A and 39B, the air flow sensor 37, and the temperature sensor 336 of the hot air circulation apparatus 3.

In this embodiment, the electric flow heaters 33 and 53 are thus used as the heat sources of the hot air circulation apparatuses 3 and the heat treatment apparatus 5. Use of the electric flow heaters 33 and 53 makes it possible to reduce the carbon dioxide emissions, contributing to prevention of global warming. When the electric flow heaters 33 and 53 are used as the heat sources, for example, a small and simple facility can be introduced, as compared to a duct electric heater or the like. Furthermore, since the same facility as that of an existing coating drying system using a gas burner can be used, it is advantageous in terms of cost. Since the heating units HP1 and HP2 are arranged inside the heating chambers 30 and 50 under a high-temperature environment, power necessary for heat generation can be reduced. In addition, since the electric connection terminals 334, 335, 534, and 535 and the introduction portions 331 and 531 are arranged outside the heating chambers 30 and 50, electric wiring workability and air path piping workability can be improved.

### Example of Processing of Control Apparatus

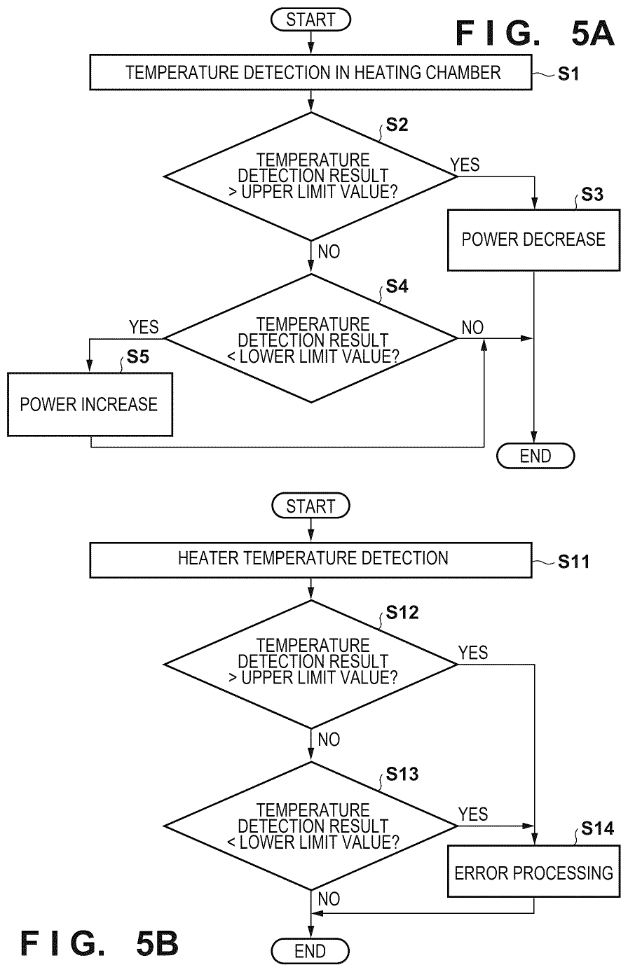

An example of control of the electric flow heater 33 and the like by the control apparatus 6 will be described. Each control to be exemplified below is periodically executed. FIG. 5A is a flowchart showing an example, and shows an example of control for maintaining the temperature of the gas blown from the electric flow heater 33 (the temperature in the heating chamber 30) within a target temperature range.

In step S1, the detection result of the temperature sensor 38 is acquired. In step S2, it is determined whether the temperature detection result acquired in step S1 exceeds a predetermined upper limit value. If the temperature detection result exceeds the upper limit value, the process advances to step S3, and otherwise, the process advances to step S4.

In step S3, power supplied to the heating elements 338 is decreased. In step S4, it is determined whether the temperature detection result acquired in step S1 is less than a predetermined lower limit value. If the temperature detection result is less than the lower limit value, the process advances to step S5, and otherwise, the processing is ended. In step S5, power supplied to the heating elements 338 is increased. By the above-described processing, the temperature of the gas blown from the electric flow heater 33 (the temperature in the heating chamber 30) can be maintained within the target temperature range.

FIG. 5B shows an example of control concerning abnormality determination of the heating unit HP1. In step S11, the detection result of the temperature sensor 336 is acquired. In step S12, it is determined whether the temperature detection result acquired in step S11 exceeds a predetermined upper limit value. If the temperature detection result exceeds the upper limit value, the process advances to step S14, and otherwise, the process advances to step S13. If the temperature detection result exceeds the upper limit value, it is estimated that the heating unit HP1 causes abnormal heating, and error processing is performed in step S14.

In step S13, it is determined whether the temperature detection result acquired in step S11 is less than a predetermined lower limit value. If the temperature detection result is less than the lower limit value, the process advances to step S14, and otherwise, the processing is ended. If the temperature detection result exceeds the upper limit value, it is estimated that the current value cannot be controlled, and error processing is performed in step S14. If the temperature detection result is less than the lower limit value, it is estimated that a heating element is disconnected, and error processing is performed in step S14. Examples of the error processing in step S14 are an abnormality occurrence notification to the operator, an abnormality occurrence notification to the host device, and operation stoppage of the hot air circulation apparatus 3.

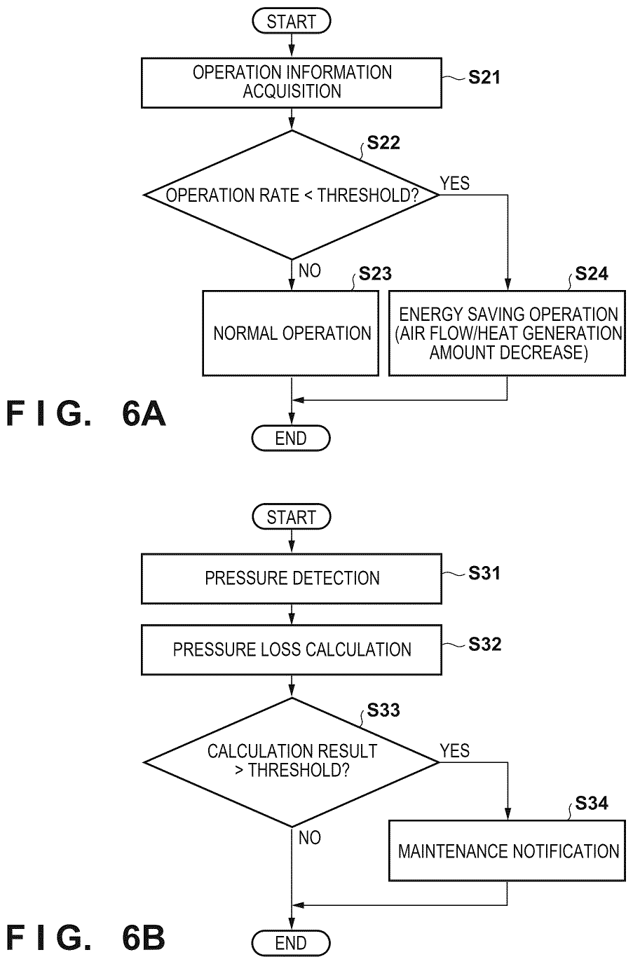

Next, FIG. 6A shows an example of processing of changing power consumption of the hot air circulation apparatus 3 in correspondence with the operation state of the system. If the number of workpieces W per unit time is small, the supply amount of the dry gas to the coating drying oven 2 may be small. On the other hand, it is necessary to prevent the temperature of the dry gas from lowering. In this embodiment, the air flow of the fans 32 and 34 is decreased, and the heat generation amount of the heating elements 338 is similarly decreased. When the air flow is decreased, the temperature of the dry gas rises. For this reason, when the heat generation amount of the heating elements 338 is lowered accordingly, the air flow can be decreased while keeping the heating temperature of the dry gas unchanged. For example, in a case where the temperature is 1,000° C. and the air flow is 100 CHM in a normal state, if the operation rate is 50%, the air flow is decreased to 50 CHM, and power supplied to the heating elements 338 is also decreased to half (assuming that the heat generation amount is proportional to the supplied power). This makes it possible to decrease the air flow to half while maintaining the temperature of the dry gas at 1,000° C..

Processing shown in FIG. 6A will be described. In step S21, information (operation information) indicating the operation rate of the coating drying system 1 is acquired. The operation information is acquired from, for example, the host device. In step S22, it is determined whether the operation rate acquired in step S21 is less than a threshold. Upon determining that the operation rate is less than the threshold, the process advances to step S24. Upon determining that the operation rate is not less than the threshold, the process advances to step S23.

In step S23, the normal operation is continued. In step S24, control is switched to an energy saving operation. In the energy saving operation, the air flow of the fans 32 and 34 and the power supplied to the heating elements 338 are decreased as compared to the normal operation, and the circulation amount is decreased while maintaining the temperature of the dry gas as in the normal operation. The processing is thus ended. By this control, power consumption can be adjusted in accordance with the operation rate of the system.

Next, FIG. 6B shows an example of processing concerning determination of exchange or maintenance of the heating unit HP1. In step S31, the detection results of the pressure sensors 39A and 39B are acquired. In step S32, pressure drop across the heating unit HP1 are calculated from the detection results acquired in step S31. In step S33, it is determined whether the pressure loss calculated in step S32 exceeds a threshold. If the pressure loss exceeds the threshold, the process advances to step S34, and otherwise, the processing is ended. If the pressure loss exceeds the threshold, clogging or the like has occurred in the support member 337, and it is estimated that the time for exchange or maintenance of the heating unit HP1 is approaching. In step S34, the operator is notified to do maintenance of the heating unit HP1. The processing is thus ended.

As described above, in this embodiment, the hot air circulation apparatus 3 can be controlled using the detection results of the temperature sensor 38, the pressure sensors 39A and 39B, and the temperature sensor 336. Note that even for the control of the heat treatment apparatus 5, the processes shown in FIGS. 5A to 6B can be performed using the detection results of the temperature sensor 58, the pressure sensors 59A and 59B, and the temperature sensor 536.

### Second Embodiment

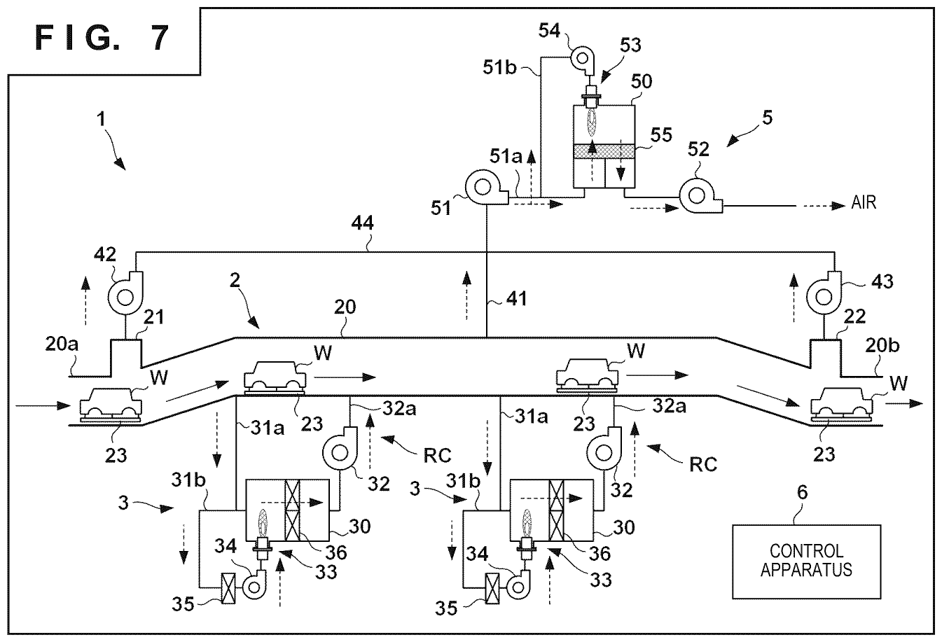

In the first embodiment, the fresh outside air FS is supplied from the fan 34 to the electric flow heater 33. However, a dry gas may be supplied. FIG. 7 shows an example. In the example shown in FIG. 7, a dry gas is supplied to a fan 34 via an air path 31b and a filter 35, and the dry gas is supplied from the fan 34 to an electric flow heater 33. Since the temperature of the dry gas is higher than that of fresh outside air FS, the power supply amount to heating elements 338 of the electric flow heater 33 can be decreased, and power consumption of a hot air circulation apparatus 3 can be reduced.

### Third Embodiment

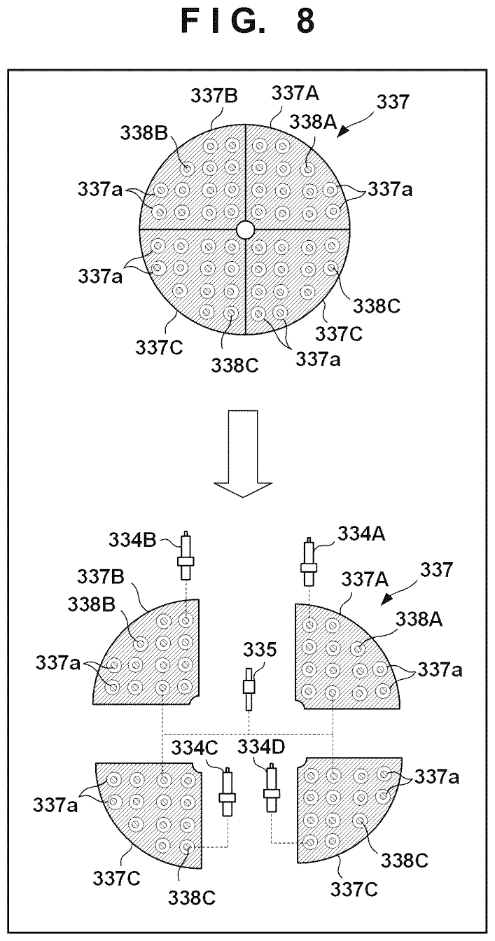

A heating unit HP1 may be formed by a plurality of sets each including the support member 337 and the heating elements 338. If clogging or disconnection occurs in a part of the heating unit HP1, it can be handled by partial exchange. FIG. 8 shows an example. The support member 337 shown in FIG. 8 is equally divided into four parts in the circumferential direction and is formed by support members 337A to 337D. Each of the support members 337A to 337D is a column member having a fan-shaped section and extended in the axial direction (direction D1). Heating elements 338A to 338D correspond to the support members 337A to 337D, respectively, and four electric connection terminals 334A to 334D are provided in correspondence with the heating elements 338A to 338D. An electric connection terminal 335, which is set to the GND potential, is shared as one terminal, but four electric connection terminals may be provided in correspondence with the heating elements 338A to 338D.

According to this embodiment, even if a trouble occurs in the support member 337A or the heating element 338A, gas heating can be continued by the remaining support members 337B to 337D and heating elements 338B to 338D. Also, the set of the support member 337A and the heating element 338A is exchanged with a new one, and the remaining support members 337B to 337D and heating elements 338B to 338D can be used continuously, improving the advantage concerning cost. Note that although the heating unit HP1 has been described here, this also applies to a heating unit HP2.

### Fourth Embodiment

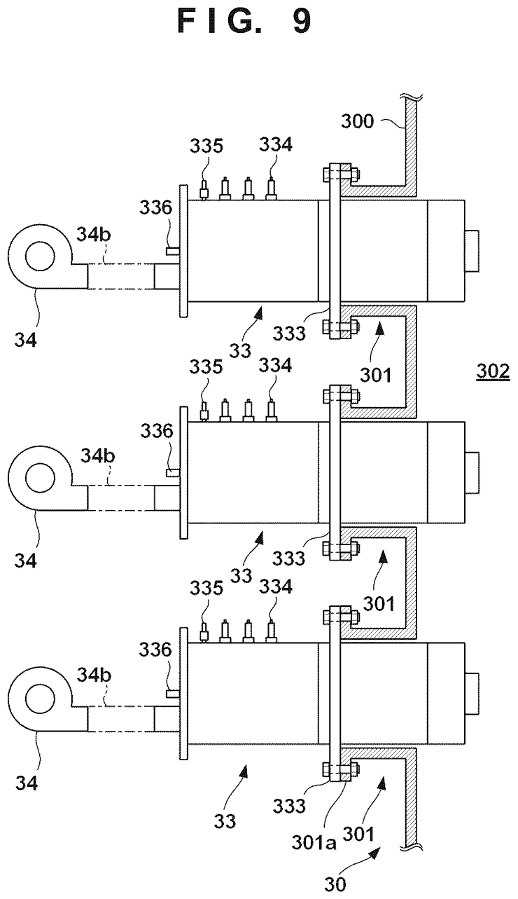

A plurality of electric flow heaters 33 to be independently driven may be attached to one heating chamber 30. FIG. 9 shows an example. In the example shown in FIG. 9, three electric flow heaters 33 are fixed to one heating chamber 30. Three attachment portions 301 are provided on a wall portion 300 of the heating chamber 30, and the electric flow heater 33 is fixed to each attachment portion 301.

When the plurality of electric flow heaters 33 are provided for the heating chamber 30 and independently driven, it is possible to perform control for, for example, driving all the three electric flow heaters 33, making one rest and driving the remaining two electric flow heaters 33, or driving only one electric flow heater 33. For example, even if the circulation amount of a dry gas is adjusted, or some electric flow heaters 33 malfunction, the operation of the system can be continued.

In the example shown in FIG. 9, a fan 34 is individually assigned to each electric flow heater 33, but one fan 34 may be shared. Also, a plurality of electric flow heaters 53 to be independently driven may be provided for the heating chamber 50.

### Fifth Embodiment

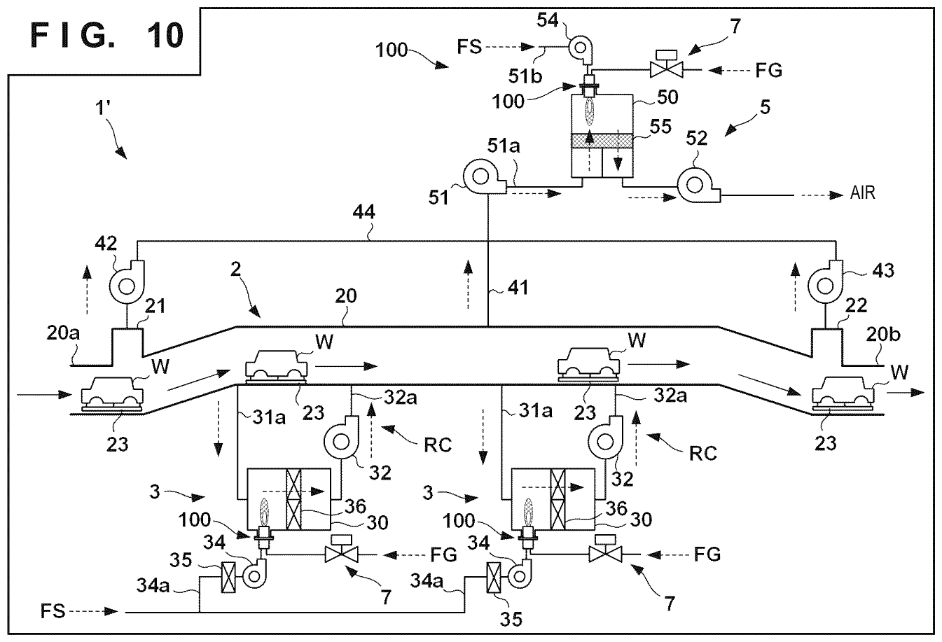

In an existing coating drying system using a gas burner as a heat source, the heat source may be exchanged with an electric flow heater, thereby replacing the system with an electrified system. FIG. 10 shows an existing coating drying system 1′ using a gas burner 100 as a heat source, which has the same configuration as the coating drying system 1 shown in FIG. 1 except that the heat source is the gas burner 100. A fuel gas FG is supplied to the gas burner 100 by a supply facility 7.

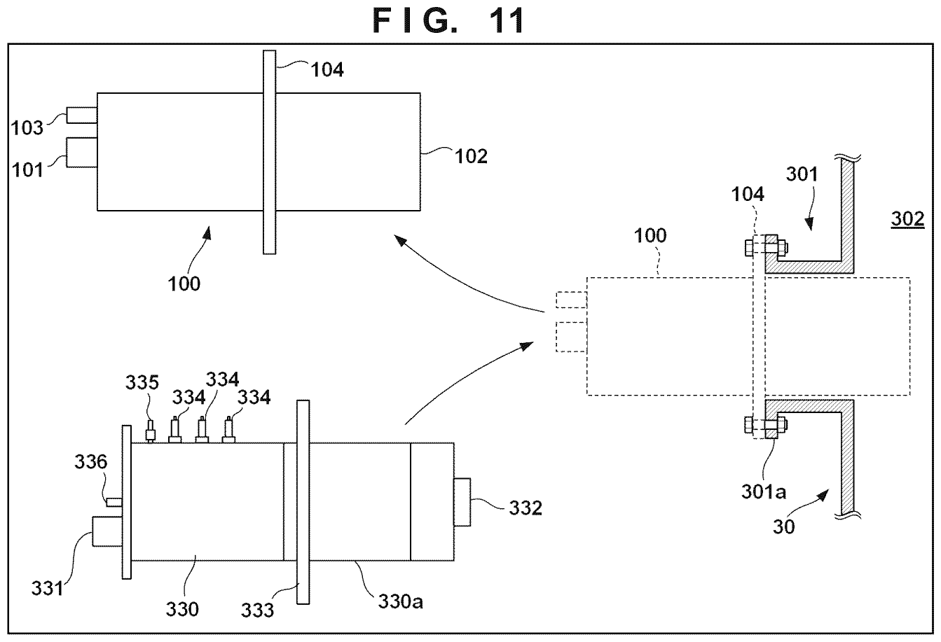

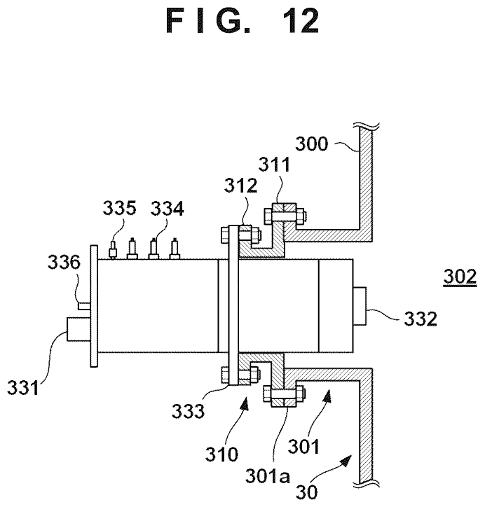

FIG. 11 shows a heat source exchange method and particularly schematically shows an example of exchange of the heat source of a hot air circulation apparatus 3. The gas burner 100 includes a flange portion 104 attached to an attachment portion 301 of a heating chamber 30, and also includes an introduction portion 103 for the fuel gas FG and an introduction portion 110 for fresh outside air FS. The gas burner 100 is detached from the attachment portion 301, and an electric flow heater 33 is attached to the attachment portion 301. A method of exchanging the heat source of the heat treatment apparatus 5 is the same as described above. When the fuel gas FG supply facility 7 is removed, and a supply facility of power to heating elements 338 is added, each of the existing hot air circulation apparatus 3 and the heat treatment apparatus 5 each using the gas burner 100 as a heat source can be replaced as an electrified heat treatment apparatus. As a result, the same system as the coating drying system 1 shown in FIG. 1 can be obtained. That is, the existing coating drying system 1′ using the gas burner 100 as a heat source can relatively easily be electrified by exchanging the gas burners with the electric flow heaters 33 and 53 with a relatively similar form.

If it is difficult, in the viewpoint of dimensions, to attach the electric flow heater 33 to the attachment portion 301 of the heating chamber 30 to which the gas burner 100 was attached, it may be attached via an adapter. FIG. 12 shows an example. An adapter 310 has a cylindrical shape, and has a flange portion 311 at one end portion and a flange portion 312 at the other end portion. The flange portion 311 has dimensions adaptive to the attachment portion 301, and the flange portion 312 has dimensions adaptive to a flange portion 333 of the electric flow heater 33. When the flange portion 311 and the attachment portion 301 are fastened, and the flange portion 312 and the flange portion 333 are fastened, the electric flow heater 33 can be fixed to the heating chamber 30. The electric flow heater 53 can also be attached to the heating chamber 50 via an adapter in a similar manner.

The invention is not limited to the foregoing embodiments, and various variations/changes are possible within the spirit of the invention.

What is claimed is:

1. A hot air generation apparatus for performing heating processing concerning a dry gas in a coating drying oven, comprising:
a heating chamber to which the dry gas is supplied; and
an electric flow heater attached to a wall portion of the heating chamber,
wherein the electric flow heater comprises:
a heating unit provided with a heating element;
an introduction portion provided outside the heating chamber to introduce a gas to pass through the heating unit;
a discharge portion provided inside the heating chamber to discharge the gas that has passed through the heating unit; and
an electric connection terminal provided outside the heating chamber and configured to supply power to the heating element.

2. The hot air generation apparatus according to claim 1, wherein
the heating unit comprises a support member made of ceramic and having a through hole formed therein, and
the heating element is provided in the through hole, and the gas is caused to pass through the through hole.

3. The hot air generation apparatus according to claim 1, wherein
the electric flow heater comprises:
a heat insulator provided inside the heating chamber and configured to surround the heating unit; and
a cover portion made of a metal and provided inside the heating chamber to cover the heat insulator.

4. The hot air generation apparatus according to claim 3, wherein
the cover portion comprises:
an outer cylinder portion;
an end plate portion configured to cover an end portion of the outer cylinder portion; and
a cylindrical nozzle portion formed on the end plate portion to form the discharge portion.

5. The hot air generation apparatus according to claim 3, wherein
the electric flow heater comprises
a flange portion integrated with the cover portion to fix the electric flow heater to the wall portion.

6. The hot air generation apparatus according to claim 4, wherein
the electric flow heater comprises
a flange portion integrated with the cover portion to fix the electric flow heater to the wall portion.

7. The hot air generation apparatus according to claim 1, wherein
the hot air generation apparatus is a hot air circulation apparatus comprising a circulation unit configured to return the dry gas heated in the heating chamber to the coating drying oven.

8. The hot air generation apparatus according to claim 1, wherein
the dry gas is introduced to the introduction portion.

9. The hot air generation apparatus according to claim 8, wherein
the hot air generation apparatus is a heat treatment apparatus configured to burn and detoxify harmful substances in the dry gas and discharge the dry gas.

10. The hot air generation apparatus according to claim 1, comprising
a detector configured to detect a pressure loss of the gas passing through the electric flow heater.

11. The hot air generation apparatus according to claim 1, comprising
a detector configured to detect a temperature of the gas that has passed through the electric flow heater.

12. The hot air generation apparatus according to claim 1, comprising
a detector configured to detect an air flow of the gas passing through the electric flow heater.

13. The hot air generation apparatus according to claim 1, comprising:
a fan configured to supply the gas to the introduction portion; and
a controller configured to control the fan and power to be supplied to the heating element,
wherein the control unit executes processing for making a control state transition from a first control state to a second control state in which an air flow of the fan and the power are decreased as compared to the first control state.

14. The hot air generation apparatus according to claim 1, wherein
a plurality of electric flow heaters to be independently driven are provided on the wall portion.

15. The hot air generation apparatus according to claim 1, wherein
the heating unit comprises a plurality of sets each including the heating element and a support member made of ceramic and configured to support the heating element.
